(19) United States
(12) Patent Application Publication
(10) Pub. No.: US 2023/0256911 A1
(43) Pub. Date: Aug. 17, 2023

(54) STORAGE DEVICE FOR A VEHICLE

(71) Applicant: BROSE FAHRZEUGTEILE SE & CO. KOMMANDITGESELLSCHAFT, COBURG, Coburg (DE)

(72) Inventors: Michael HÖPPEL, Bad Staffelstein (DE); Fabian LANG, Markt Nordheim (DE)

(73) Assignee: BROSE FAHRZEUGTEILE SE & CO. KOMMANDITGESELLSCHAFT, COBURG, Coburg (DE)

(21) Appl. No.: 18/015,205

(22) PCT Filed: Jul. 5, 2021
(86) PCT No.: PCT/EP2021/068469

§ 371 Date: Jan. 9, 2023

(30) Foreign Application Priority Data
Jul. 9, 2020 (DE) 10 2020 208 630.3

(51) Int. Cl. B60R 7/04

(52) U.S. Cl. CPC B60R 7/04

(57) ABSTRACT

A storage device for a vehicle, having a plurality of containers, for receiving objects to be stored, at least one removal region which is designed to receive at least one of the containers such that the at least one container and/or objects from the at least one container can be removed by a user; a stowing area for receiving containers which are not positioned in the at least one removal region; and a positioning assembly for adjusting the containers along an adjustment path between the stowing area and the at least one removal region; wherein the positioning assembly has at least one first drive element and at least one second drive element, and an adjustment force can be transmitted onto at least one of the containers selectively either via the first drive element or the second drive element depending on whether the container is to be adjusted between a first adjustment position along the adjustment path and a second adjustment position along the adjustment path or between the second adjustment position and a third adjustment position along the adjustment path.

### CROSS-REFERENCE TO RELATED APPLICATIONS

This application is the U.S. National Phase of PCT Application No. PCT/EP2021/068469 filed on Jul. 5, 2021, which claims priority to German Patent Application No. DE 10 2020 208 630.3, filed on Jul. 9, 2020, the disclosures of which are hereby incorporated in their entirety by reference herein.

### TECHNICAL FIELD

The present disclosure relates to a storage device for a vehicle.

### BACKGROUND

Vehicles may include one or more storage devices for storing a user’s objects within the vehicle. Such a storage device includes at least a plurality of containers for receiving objects to be stored, at least one removal area and a stowage space. The at least one removal area here is adapted to receive at least one of the containers in such a way that the at least one container and/or objects from the at least one container can be removed by a user. Furthermore, the stowage space is adapted to receive containers not positioned in the at least one removal area. In addition, such a storage device includes a positioning assembly for adjusting the at least one container along an adjustment path between the stowage space and the at least one removal area.

Storage devices of this type substantially correspond to the paternoster principle and can be employed for example for adjusting a plurality of containers via the positioning assembly. The plurality of containers can be stored for example in the stowage space. Thus, an access by a user to the objects stored in the containers can be inhibited. Furthermore, the positioning assembly can be used to adjust for example exactly one of the plurality of containers into the at least one removal area. This can provide for access by a user to the objects stored in the exactly one container. As an example, individual or all containers can be rotatably arranged on the positioning assembly in such a way that the containers align with the direction of earth’s gravity. This allows liquids stored in the containers in open vessels to also remain in the vessel during an adjustment. With a non-linear adjustment path, such alignment with the earth’s gravity entails the rotation of the containers relative to the adjustment path.

### SUMMARY

According to one embodiment, a storage device is provided. The storage device includes a plurality of containers for receiving objects to be stored, at least one removal area and a stowage space. The at least one removal area here is adapted to receive at least one of the containers in such a way that the at least one container and/or objects from the at least one container can be removed by a user. Furthermore, the stowage space is adapted to receive containers not positioned in the at least one removal area. In addition, such a storage device includes a positioning assembly for adjusting the at least one container along an adjustment path between the stowage space and the at least one removal area. Furthermore, the positioning assembly includes at least one first drive element and at least one second drive element. Via either the first drive element or the second drive element an adjusting force can selectively be transmitted to at least one of the containers, depending on whether the container is to be adjusted between a first adjustment position along the adjustment path and a second adjustment position along the adjustment path or between the second adjustment position and a third adjustment position along the adjustment path.

The at least two drive elements of the positioning assembly in principle provide for transmitting different adjusting forces to individual containers from the plurality of containers. The different adjusting forces, for example, can be transmitted in dependence on an adjustment position of the containers along the adjustment path. The adjusting forces can be designed independently of each other.

For example, a first adjusting force can be transmitted to all containers positioned between the first and second adjustment positions. Analogously, a second adjusting force by way of example can be transmitted to all containers positioned between the second and third adjustment positions. Corresponding to the first and second adjusting forces to be designed independently of each other, in particular two different adjusting forces can be transmitted. Thus, the containers between the first and second adjustment positions and the containers between the second and third adjustment positions can be adjusted with adjustment speeds of different magnitude and sign.

Corresponding to the first and second adjusting forces to be designed independently of each other it can apply in principle that in dependence on the adjustment position of the containers the first adjusting force is greater than the second adjusting force, or the second adjusting force is greater than the first adjusting force, or both adjusting forces are the same. In particular, the first or the second adjusting force can be zero in dependence on the adjustment positions of the containers. Furthermore, the first or the second adjusting force can be negative in dependence on the adjustment positions of the containers, or both adjusting forces can be negative. In the sense of the disclosed teaching, the sign of the adjusting forces relates to an acceleration of the container on which the adjusting force acts, along (positive) or against (negative) the adjustment path.

In one design variant, the at least two drive elements furthermore are arranged with respect to each other in such a way that a first adjustment direction along the adjustment path, which points from the first adjustment position to the second adjustment position, and a second adjustment direction along the adjustment path, which points from the second adjustment position to the third adjustment position, extend at an angle to each other. The adjustment path thus has a corner in the region of the second adjustment position, in the region of which corner the adjustment path includes the angle. In the case of a closed adjustment path, the angle included at the corner corresponds to the interior angle of the adjustment path at the corner. In the case of a non-closed adjustment path, the angle corresponds to the smaller one of the two possible angles, whose vertex is formed by the second adjustment position and whose legs are formed by the first and second adjustment directions.

When the first and the second adjustment speed have the same magnitude, different adjustment directions result in non-disappearing relative adjustment speeds of the containers between the first and second adjustment positions and of the containers between the second and third adjustment positions. Such a relative adjustment speed can lead to a contact of the containers in the region of the corner. To inhibit such a contact, the containers correspondingly can be adjusted between the first and second adjustment positions with an adjustment speed of different magnitude than the containers between the second and third adjustment positions. The deviation of the first and the second adjustment speed in terms of magnitude can be designed in such a way that the relative adjustment speed is zero.

In principle, it is possible to prevent that at a corner of the adjustment path the individual containers have a relative adjustment speed towards each other. Thus, it can be prevented that the containers get in contact with each other. A minimum spacing of the containers to each other in principle can be reduced with respect to the prior art independently of angles of possible corners of the adjustment path. The possible number of the containers in a storage device thereby can be increased significantly with the required installation space remaining the same.

Even with a small minimum spacing, the at least two drive elements can be arranged with respect to each other in such a way that the first adjustment direction and the second adjustment direction extend at an angle of 90° to each other.

To realize a closed circulating movement of the containers in the storage device, a connection of a particular container to one of the first and second drive elements in at least one of the adjustment positions can be released via the positioning assembly. Furthermore, the one particular container can be connected to the other drive element of the first and second drive elements via the positioning assembly.

Accordingly, the positioning assembly is adapted to connect the one particular container to the one drive element in at least one of the adjustment positions and to release the connection to the other drive element. Releasing and connecting the one container to the drive elements can be carried out at the same time or one after the other. Thus, it is possible for example that the one container temporarily is connected to both or none of the two drive elements.

Thus, to realize a transmission of direction-dependent adjusting forces to at least one container, the positioning assembly in a switching position, for example, can be adapted to switch between the connection of the at least one container to the one of the at least two drive elements and the connection of the at least one container to another one of the two drive elements. As an example, in design variants of the storage device without a closed circulating movement, the positioning assembly in said switching position can also be adapted to switch between the connection of the at least one container to at least two drive elements. Furthermore, the positioning assembly in principle can also have a plurality of switching positions.

In another design variant, the positioning assembly includes a third drive element, wherein via the third drive element the adjusting force selectively can be transmitted to at least one of the containers, depending on whether the container is to be adjusted between the third adjustment position and a fourth adjustment position along the adjustment path or between a pairing of the adjustment positions deviating from the third and fourth adjustment positions.

The positioning assembly likewise can include a fourth drive element, wherein via the fourth drive element the adjusting force selectively can be transmitted to at least one of the containers, depending on whether the container is to be adjusted between the fourth adjustment position and a fifth adjustment position along the adjustment path or between a pairing of the adjustment positions deviating from the fourth and fifth adjustment positions. To realize the closed circulating movement, the fifth adjustment position by way of example can correspond with the first adjustment position. In principle, however, the number of drive elements is not limited. Thus, with n linear drive elements for example n-polygonal adjustment paths can be realized. Each of the n corners here represents an adjustment position of the adjustment path.

In one configuration of an n-polygonal adjustment path, the first adjustment position in the at least one removal area of the storage device and the (n-1) further adjustment positions can be arranged in the stowage space of the storage device. In principle, however, the n adjustment positions can be arbitrarily distributed on the stowage space and the at least one removal area.

In another exemplary embodiment, individual substantially linear drive elements likewise can be arranged with one end at an n-corner formed by n drive elements. The adjustment path formed by means of the drive elements substantially can include a closed circumferential portion substantially corresponding to the n-corner and at least one linear portion formed by the individual linear drive elements. The linear portion here can be arranged on the circumferential portion in such a way that the positioning assembly in one of the switching positions is adapted to switch between a connection of a container to the circumferential portion and to the linear portion. Such a linear portion thus can connect a portion of the adjustment path circumferentially extending in the stowage space to the at least one removal area. In addition, the drive elements in principle can also be arranged in such a way that the same realize a plurality of circumferential adjustment path portions. The plurality of circumferential adjustment path portions can be connected to each other via joint switching positions or at least one linear portion.

In a design variant of the positioning assembly, the positioning assembly can include exactly two drive elements. In principle, a closed circulating movement can also be realized with two drive elements. The reduction of the number of drive elements can reduce a complexity of the positioning assembly. The reduced complexity in turn can reduce an assembly expenditure and manufacturing costs.

The first drive element of the exactly two drive elements, for adjusting the container along the adjustment path between the first and second as well as third and the fourth adjustment positions, therefor can be of the circulating type. As an endless structure, such a drive element, for example may have no free ends.

In an analogous configuration of the second drive element, for adjusting the containers along the adjustment path between the second and third as well as the fourth adjustment position and first adjustment position, the same can also be of the circulating type.

Each of the circulating drive elements can be arranged with respect to at least one further drive element in such a way that at one or more switching positions the positioning assembly is adapted to switch between the connection of at least one container to the circulating drive element and the further drive element. Thus, the positioning assembly can be adapted to selectively transmit an adjusting force to at least one of the containers via either the circulating drive element or the further drive element. As an example, the further drive element can also be a circulating drive element. The positioning assembly in at least two switching positions therefor can be adapted to switch between the connection of the container to the one of the two circulating drive elements and the connection of the at least one container to the other one of the two circulating drive elements.

In another design variant, the two circulating drive elements are arranged with respect to each other in such a way that a third adjustment direction pointing along the adjustment path from the third to the fourth adjustment position is aligned antiparallel to the first adjustment direction. Likewise, a fourth adjustment direction pointing along the adjustment path from the fourth to the first adjustment position can be aligned antiparallel to the second adjustment direction.

Thus, a container can be adjusted by means of the positioning assembly via a sequential adjustment along the first adjustment direction, the second adjustment direction, the third adjustment direction and the fourth adjustment direction on a closed circulating movement.

In one configuration of the storage device, the positioning assembly has an adjustment path corresponding to a contour of a parallelogram. The four corners of the parallelogram here can correspond to four adjustment positions. Thus, two adjustment positions each are associated with an acute angle and two are associated with an obtuse angle. To reduce the minimum spacing of the containers to each other, the adjustment positions can each be formed as switching positions with the associated acute angle. In an exemplary embodiment, the positioning assembly can be adapted, in a first and a second switching position, corresponding to the second adjustment position and fourth adjustment position, to switch between the connection of one of the containers to the first circulating drive element and the second circulating drive element.

In another configuration of the storage device comprising two circulating drive elements, the containers are adjustable along a rectangular adjustment path, wherein all corners include an angle of 90°. The four corners of the rectangular adjustment path can be switching positions. Thus, the positioning assembly in the second switching position can be adapted to switch between the connection of one of the containers to the first circulating drive element and the second circulating drive element. The positioning assembly in the third switching position furthermore can be adapted to switch between the connection of the container to the second circulating drive element and the first circulating drive element. Furthermore, the positioning assembly in the fourth switching position can be adapted to switch between the connection of the container to the first circulating drive element and the second circulating drive element. Furthermore, the positioning assembly in the first switching position can be adapted to switch between the connection of the container to the second circulating drive element and the first circulating drive element.

Furthermore, in each of the aforementioned embodiments the positioning assembly can define at least one guideway for guiding the containers during the adjustment within the stowage space. Such a guideway can be adapted to support the weight force of each individual container and of the objects possibly stored in the container. Thus, the guideway can relieve the at least two drive elements. In addition, the guideway may be adapted to support the containers in the switching positions in such a way that the drive elements adjacent in the switching positions are unloaded as regards the weight force of the containers in the switching positions.

In one configuration, the at least one guideway can be a slotted link guide. For this purpose, the containers can each sectionally engage in the slotted link guide. To realize the possibility of removal of the containers from the storage device in the at least one removal area, the storage device can be shaped such that only containers positioned in the stowage space engage in the slotted link guide.

In another configuration of the storage device, the containers have a rotatable engagement portion to realize a rotatable support in the guideway, via which engagement portion the containers are guided along the at least one guideway.

Furthermore, the storage device in each of the design variants can include a drive for sequentially shifting the containers between the adjustment positions. The drive can be adapted to selectively drive the at least two drive elements individually or jointly.

In the following, an exemplary circulation of at least one container is outlined in a design variant of the storage device with four switching positions and two drive elements. In an exemplary starting position at least one of the containers is positioned in the stowage space at an adjustment position between the first and second switching positions. By exclusively driving the first drive element in a first driving direction of the first drive element, the container observed can be adjusted along the first adjustment direction to the second switching position. The positioning assembly in the second switching position here is adapted to release the connection of the container observed to the first drive element and to establish the connection to the second drive element. By exclusively driving the second drive element in a first driving direction of the second drive element, the container observed can then be adjusted along the second adjustment direction to the third switching position. Independently of the angle associated with the second switching position, a contact of two containers in the region of the second switching position can be avoided. As an example, by exclusively driving the second drive element, a contact with containers that are connected to the first drive element can be avoided. In the third switching position the positioning assembly is adapted to release the connection of the container observed to the second drive element and to establish the connection to the first drive element. Analogously, the container observed can be adjusted up to the first adjustment position. The first adjustment position by way of example can be arranged in the at least one removal area of the storage device.

In principle, the containers can also be adjusted along the adjustment path with opposite adjustment directions by driving the at least two drive elements each in a second driving direction.

In one configuration of the design variant, the drive can be electronically controllable. As an example, the positioning assembly may include an electronic control system connected to the electronically controllable drive. Such an electronic control system can be adapted to adjust a selected container from the stowage space into the at least one removal area. For selection of a container by a user, the positioning assembly therefor can include an input module.

In an exemplary configuration, the drive elements can be chains, V-belts or threaded rods in all design variants of the storage device.

Furthermore, the containers and drive elements in all embodiments can be adapted to be connectable to each other via a plug connection in order to realize the releasable connection of the containers to the at least two drive elements. To realize the plug connection to the at least two drive elements, each container can include at least one connecting pin and each of the at least two drive elements can include at least one pin receptacle. By way of example, one of the connecting pins of a container can extend into the pin receptacle of the first drive element for transmitting the adjusting force from the first drive element to the at least one container. Furthermore, in one of the switching positions for switching the connection, the positioning assembly can be adapted to arrange the container with respect to the at least two drive elements in such a way that the at least one connecting pin of the container gets out of engagement with the pin receptacle of the first drive element. Furthermore, in the aforementioned switching position the positioning assembly can be adapted to arrange the container with respect to the at least two drive elements in such a way that the at least one connecting pin of the container gets in engagement with the pin receptacle of the second drive element. Releasing and connecting the container to the drive elements can be carried out at the same time or one after the other. As an example, each of the containers can include a plurality of connecting pins in order to be connectable to the at least two drive elements.

In an alternative configuration, the containers and drive elements in all embodiments can be adapted to be connectable to each other via a magnetic connection in order to realize the releasable connection of the containers to the at least two drive elements. In one design variant, both the containers and the drive elements therefor can include permanent-magnetic connecting elements. In an alternative design variant, the containers or the drive elements can include electromagnetic connecting elements.

In another exemplary embodiment, the stowage space of the storage device can include a cooling device in order to at least sectionally cool the stowage space. Thus, objects stored in at least one of the containers can be cooled by being positioned in the cooled section of the stowage space. For the targeted adjustment of at least one container in the cooled section of the stowage space, the electronic control system can be adapted to adjust a selected container into the cooled section of the stowage space.

Alternatively or additionally, in another embodiment of the storage device the stowage space can include a heating device in order to at least sectionally warm up the stowage space. Thus, objects stored in at least one of the containers can be warmed up by being positioned in the warmed-up section of the stowage space. For the targeted adjustment of at least one container into the warmed-up section of the stowage space, the electronic control system can be adapted to adjust a selected container into the warmed-up section of the stowage space.

Via the cooling and/or heating device, objects stored in the containers thus can specifically be tempered to a preferred temperature. An embodiment that includes both the cooling and the heating device thus can be adapted to temper objects to the preferred temperature independently of an ambient temperature. For isolating a cooled section from an uncooled section or a warmed-up section from a not warmed-up section or of a cooled section from a warmed-up section, the positioning assembly here can include at least one linear portion and a circumferential portion of the adjustment path. The linear portion can be arranged on the circumferential portion in such a way that at least one container can be adjusted along the linear portion from the warmed-up or cooled area into the uncooled or not warmed-up circumferential portion.

In principle, the storage device also can include a plurality of removal areas. By means of the plurality of removal areas, the storage device can be adapted to provide for access to at least one of the containers for one or more users at different positions. In one embodiment of the storage device comprising a plurality of removal areas, the positioning assembly can be adapted to adjust the plurality of containers along an adjustment path with a circumferential portion and a plurality of linear portions. The plurality of linear portions can be arranged on the circumferential portion in such a way that the containers are each adjustable between the stowage space and one of the removal areas via one of the linear portions, respectively. Furthermore, in a plurality of switching positions the positioning assembly can be adapted to switch between a connection of a container to the circumferential portion and one of the linear portions, respectively.

In a design variant, one of said embodiments of the storage device can form part of a center console of a vehicle.

In all embodiments that include an electronic control system for electronically controlling the drive elements, the electronic control system can be connected to an on-board computer of the vehicle. Thus, a container can be selected via the on-board computer so as to be adjusted into the at least one removal area.

Such a center console can include an armrest surface which may be arranged on an upper side of the center console facing the vehicle roof.

In one embodiment of the center console, the adjustment path of the storage device can include a linear portion and a circumferential portion. The linear portion here can be arranged on the circumferential portion with one end in such a way that in a switching position the positioning assembly is adapted to switch between a connection of a container to the circumferential portion and the linear portion. Thus, such a linear portion can connect the circumferential portion of the adjustment path to the at least one removal area. Such a linear portion may be aligned substantially vertically. The center console in principle can include an access portion that provides access for a user to the containers positioned in the at least one removal area of the storage device.

In another embodiment of the center console, the storage device also can include a plurality of removal areas. Each of the removal areas can be arranged at a different position within the vehicle. Accordingly, in one variant a first removal area can be arranged in the region of a dashboard in such a way that via the first removal area it is possible for a user sitting on a front seat to have access to containers. In an alternative or additional variant, a second removal area can be arranged in a rear area with respect to the vehicle in such a way that via the second removal area it is possible for a user sitting in the back of the vehicle to have access to containers.

The embodiments described above for the storage device are also applicable analogously to the center console.

### BRIEF DESCRIPTION OF THE DRAWINGS

The attached Figures by way of example illustrate possible embodiments of the proposed solution. In the drawings:

FIG. 1 shows a schematic representation of a first embodiment of the storage device comprising two containers, a stowage space and a removal area for the containers, and two drive elements for adjusting the containers along an adjustment path;

FIG. 2 shows a schematic representation of a second embodiment of the storage device with a non-linear adjustment path;

FIG. 3 shows a schematic representation of a third embodiment of the storage device comprising two containers and a third drive element;

FIG. 4A shows a schematic representation of a fourth embodiment of the storage device comprising six containers, a circumferential adjustment path and two circulating drive elements;

FIG. 4B shows another schematic representation of the storage device shown in FIG. 4A with containers adjusted with respect to FIG. 4A;

FIG. 4C shows another schematic representation of the storage device shown in FIG. 4A with containers adjusted with respect to FIGS. 4A and 4B;

FIG. 5 shows a schematic representation of a fifth embodiment of the storage device comprising two containers, a linear portion and a circumferential portion of the adjustment path and two circulating drive elements as well as a linear drive element; and

FIG. 6 shows a schematic representation of a center console comprising a storage device in a simplified representation, an armrest surface and an access section.

### DETAILED DESCRIPTION

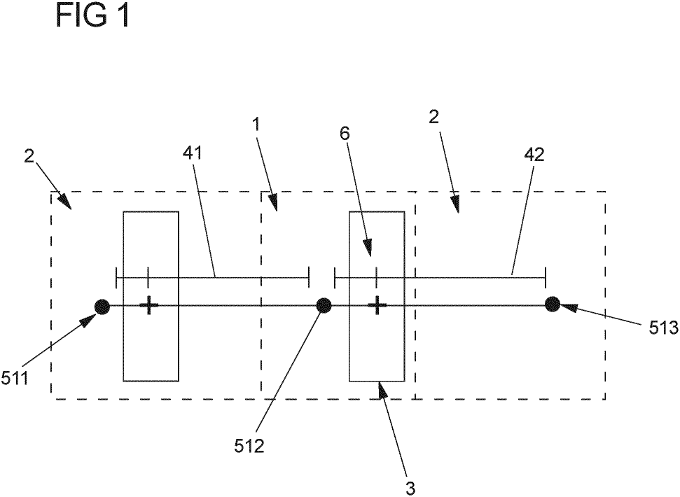

FIG. 1 shows a schematic representation of a first embodiment of the storage device. Such a storage device comprises at least two containers 3 for receiving objects to be stored, a removal area 1 and a stowage space 2. The removal area 1 here is adapted to receive at least one of the containers 3 in such a way that the at least one container 3 and/or objects from the at least one container 3 can be removed by a user. Furthermore, the stowage space 2 is adapted to receive containers 3 not positioned in the removal area 1. In addition, such a storage device includes a positioning assembly for adjusting the at least one container 3 along an adjustment path 5 between stowage space 2 and removal area 1. Furthermore, the positioning assembly includes at least one first drive element 41 and at least one second drive element 42. Via the first drive element 41 or the second drive element 42 an adjusting force can selectively be transmitted to at least one of the containers 3, depending on whether the container 3 is to be adjusted between a first adjustment position 511 along the adjustment path 5 and a second adjustment position 512 along the adjustment path 5 or between the second adjustment position 512 and a third adjustment position 513 along the adjustment path 5.

In the embodiment shown in FIG. 1, the adjustment path 5 linearly connects the first adjustment position 511 to the second adjustment position 512 and the second adjustment position 512 to the third adjustment position 513. Both the first adjustment position 511 and the third adjustment position 513 here are each located in a section of the stowage space 2. The second adjustment position 512 on the other hand is arranged in the removal area 1. Thus, in the exemplary embodiment of the storage device shown in FIG. 1 the two sections of the stowage space 2 are separated from each other by the removal area 1 arranged therebetween.

Parallel to the adjustment path 5, the first drive element 41 is arranged between the first and the second adjustment position 511, 512. A first container 3 is connected to the first drive element 41 by means of a plug connection 6. Thus, a first adjusting force can be transmitted to the first container 3 positioned between the first and second adjustment positions 511, 512. The first container 3 herewith is adjustable along the adjustment path 5 between the first adjustment position 511 and the second adjustment position 512. As an example, the first container 3 can thus be adjusted between the stowage space 2 and the removal area 1 via the first drive element 41.

Analogously, the second drive element 42 is arranged parallel to the adjustment path 5 between the second and third adjustment positions 512, 513. A second container 3 here is connected to the second drive element 42 by means of a further plug connection 6. Thus, a second adjusting force can be transmitted to the second container 3 positioned between the second and third adjustment positions 512, 513. Thus, the second container 3 is adjustable along the adjustment path 5 between the second adjustment position 512 and the third adjustment position 513. In one or more embodiments, the second container 3 can thus be adjusted between the stowage space 2 and the removal area 1 via the second drive element 42.

Corresponding to the first and second adjusting forces to be designed independently of each other e.g., two different adjusting forces can be transmitted. Thus, the containers 3 can be adjusted between the first and second adjustment positions 511, 512 and between the second and third adjustment positions 512, 513 with adjustment speeds of different magnitude and sign.

In the embodiment shown in FIG. 1, for example, both containers 3 can be adjusted into the removal area 1.

In an alternative embodiment deviating from the illustrated embodiment, the adjustment path 5 in principle can also be of the non-linear type. By way of example, this can be realized by using non-linear drive elements 41, 42. In addition, the stowage space 2 can be of the coherent type.

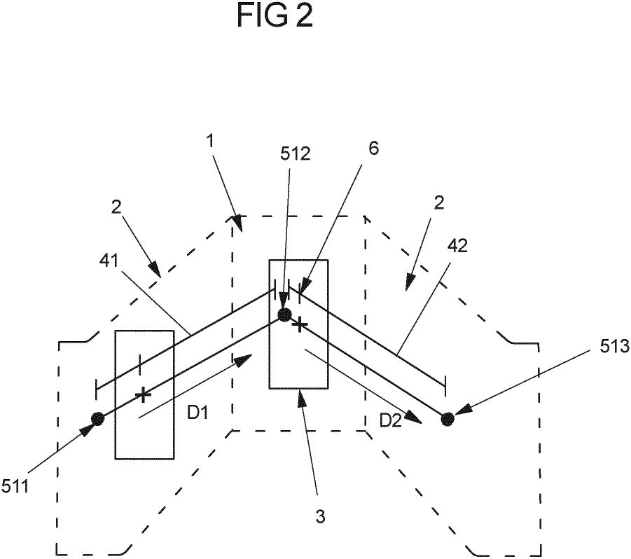

FIG. 2 shows a schematic representation of a second embodiment of the storage device with a non-linear adjustment path 5. In the second embodiment, the adjustment path 5 connects the first adjustment position 511 to the second adjustment position 512 and the second adjustment position 512 to the third adjustment position 513 in a non-linear way. The two drive elements 41, 42 are arranged with respect to each other in such a way that a first adjustment direction D1 along the adjustment path 5, which points from the first adjustment position 511 to the second adjustment position 512, and a second adjustment direction D2 along the adjustment path 5, which points from the second adjustment position 512 to the third adjustment position 513, extend at an angle to each other.

Both the first adjustment position 511 and the third adjustment position 513 here are each located in a section of the stowage space 2. The second adjustment position 512 on the other hand is arranged in the removal area 1. Thus, in the exemplary embodiment of the storage device shown in FIG. 2 the two sections of the stowage space 2 are separated from each other by the removal area 1 arranged therebetween.

Analogous to the embodiment shown in FIG. 1, the first drive element 41 is arranged parallel to the adjustment path 5 between the first and second adjustment positions 511, 512. The first container 3 is connected to the first drive element 41 by means of the plug connection 6. Thus, the first adjusting force can be transmitted to the first container 3 positioned between the first and second adjustment positions 511, 512. The first container 3 herewith is adjustable along the adjustment path 5 between the first adjustment position 511 and the second adjustment position 512. As an example, the first container 3 can thus be adjusted between the stowage space 2 and the removal area 1 via the first drive element 41.

Analogously, the second drive element 42 is arranged parallel to the adjustment path 5 between the second and third adjustment positions 512, 513. The second container 3 here is connected to the second drive element 42 by means of the further plug connection 6. Thus, the second adjusting force can be transmitted to the second container 3 positioned between the second and third adjustment positions 512, 513. The second container 3 herewith is also adjustable along the adjustment path 5 between the second and third adjustment positions 512, 513. As an example, the second container 3 can thus be adjusted between the stowage space 2 and the removal area 1 via the second drive element 42.

Corresponding to the first and second adjusting forces to be designed independently of each other such as two different adjusting forces can be transmitted. Thus, the containers 3 between the first and second adjustment positions 511, 512 and the containers 3 between the second and third adjustment positions 512, 513 can be adjusted with adjustment speeds of different magnitude and sign.

Thus, in the embodiment shown in FIG. 2 for example both containers 3 can be adjusted into the removal area 1.

Furthermore, in deviating embodiments the adjustment positions 511, 512, 513 in principle can also be distributed on the stowage space 2 and the removal area 1 with a deviating arrangement. Thus, by way of example, the first and third adjustment positions 511, 513 can also be arranged in the removal area 1 and the second adjustment position 512 can be arranged in the stowage space. In addition, the two drive elements 41, 42 can also be arranged with respect to each other in such a way that the first adjustment direction D1 and the second adjustment direction D2 extend at an angle of 90° to each other.

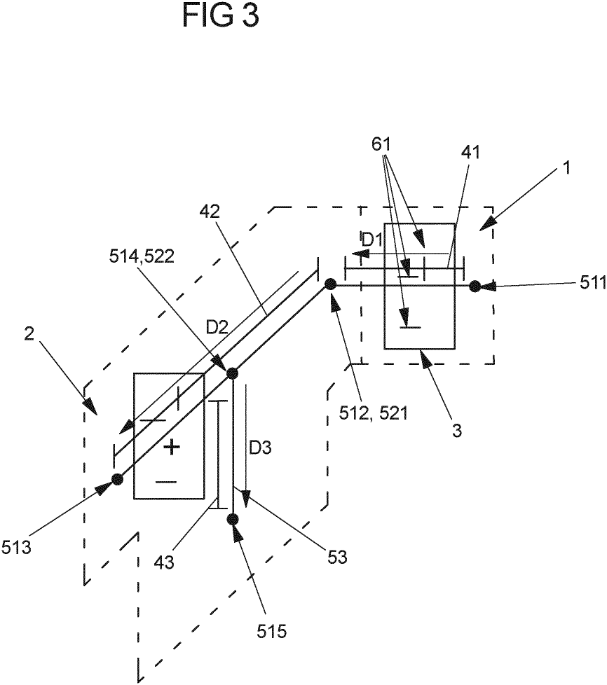

FIG. 3 shows a schematic representation of a third embodiment of the storage device with a further drive element 43. In the third embodiment, the adjustment path 5 connects the first adjustment position 511 to the second adjustment position 512 and the second adjustment position 512 to the third adjustment position 513 in a non-linear way. Furthermore, the adjustment path 5 includes a linear portion 53 which extends from a fourth adjustment position 514 arranged between the second adjustment position 512 and the third adjustment position 513 to a fifth adjustment position 515.

The first and the second drive element 41, 42 are arranged with respect to each other in such a way that the first adjustment direction D1, which points from the first adjustment position 511 to the second adjustment position 512, and the second adjustment direction D2, which points from the second adjustment position 512 to the third adjustment position 513, extend at an angle to each other. The third drive element 42 correspondingly is arranged parallel to the linear portion 53 between the fourth and fifth adjustment positions 514, 515.

The first adjustment position 511 is located in the removal area 1, and the second, third, fourth and fifth adjustment positions 512, 513, 514, 515 each are located in the stowage space 2.

Analogous to the first and second embodiments, the embodiment shown in FIG. 3 includes two containers 3. Each of the two containers 3 comprises three connecting pins 61 for realizing the plug connection 6 with one of the drive elements 41, 42, 43, respectively. The first container 3 is connected to the first drive element 41 via one of the three connecting pins 61. Thus, the first adjusting force can be transmitted to the first container 3 positioned between the first and second adjustment positions 511, 512. The first container 3 herewith is adjustable along the adjustment path 5 between the first adjustment position 511 and the second adjustment position 512. As an example, the first container 3 can thus be adjusted between the stowage space 2 and the removal area 1 via the first drive element 41.

The positioning assembly in the second adjustment position 512 is adapted to switch between the connection of one of the containers 3 to the second drive element 42 and the first drive element 41. Hence, the second adjustment position 512 corresponds to a first switching position 521.

Analogously, the second container 3 is connected to the second drive element 42 via one of the three connecting pins 61. Thus, the second adjusting force can be transmitted to the second container 3 positioned between the second and third adjustment positions 512, 513. The second container 3 herewith is adjustable along the adjustment path 5 between the second adjustment position 512 and the third adjustment position 513.

The positioning assembly is adapted to connect one of the containers 3 in the fourth adjustment position 514 to the third drive element 43 and to release the connection to the second drive element 42. Releasing and connecting the containers 3 to the drive elements 42, 43 can be carried out at the same time or one after the other. Thus, it is possible for example that the containers 3 temporarily are connected to both or none of the two drive elements 42, 43. Consequently, the adjustment position 514 corresponds to a second switching position 522. A switching operation in the first and second switching positions 521, 522 in principle is reversible.

Thus, the design variant shown in FIG. 3 is adapted to adjust one of the containers 3 onto the linear portion 53 and thus clear the adjustment path 5 between the first and third adjustment positions 511, 513 for the respectively other container 3. Thus, an order of the containers 3 on the portion of the adjustment path 5 between the first and third adjustment positions 511, 513 can be varied via the positioning assembly.

In an additional variant, the portion of the stowage space 2 accessible via the linear portion 53 can include a cooling device or a heating device in order to temper one of the containers 3. Thus, for tempering purposes one of the containers 3 can be adjusted along a third adjustment direction D3 into the tempered section of the stowage space 2, wherein the third adjustment direction of this exemplary embodiment points from the fourth to the fifth adjustment position 514, 515.

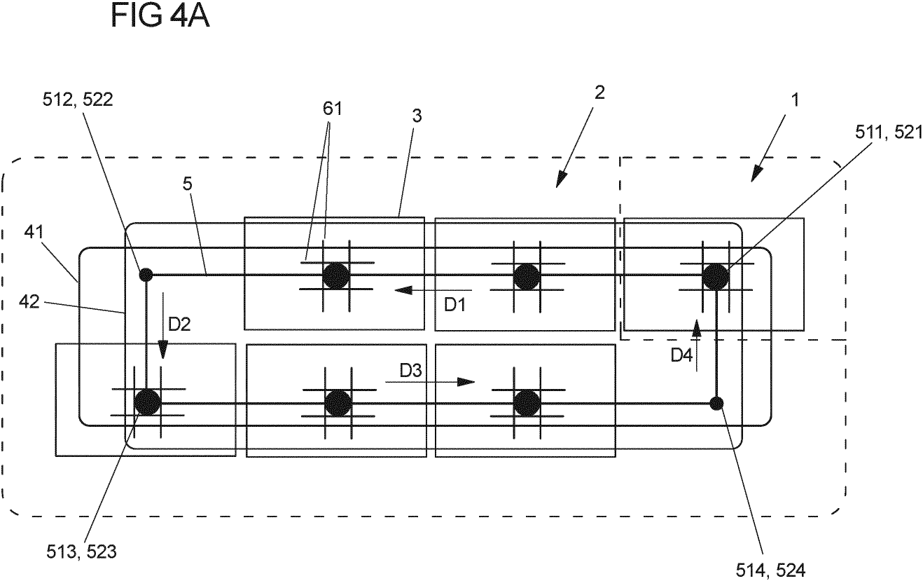

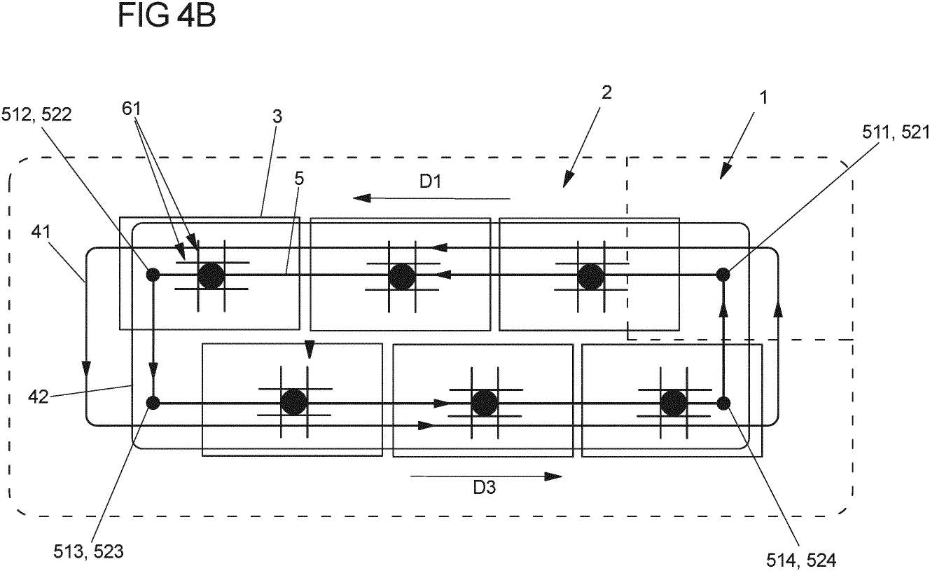

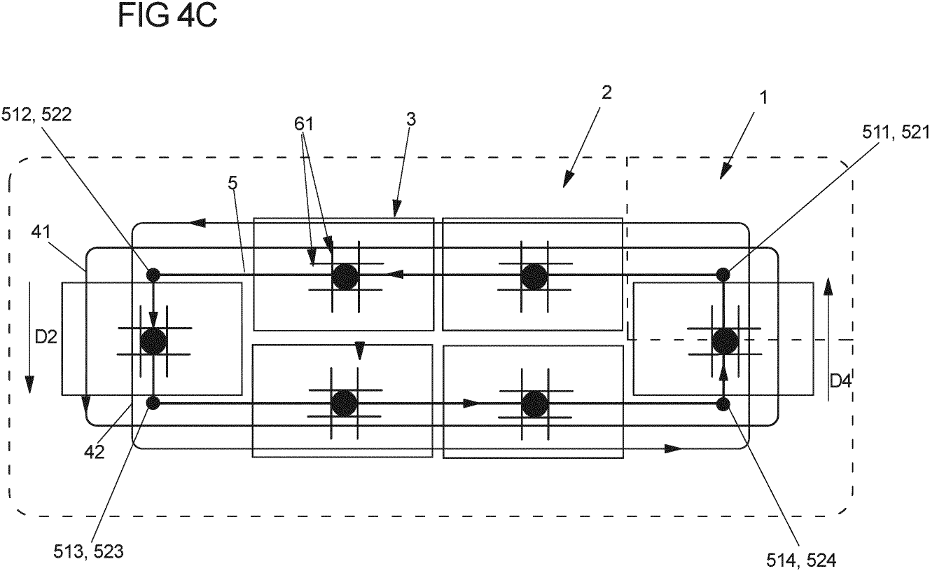

FIG. 4A shows a schematic representation of a fourth embodiment of the storage device comprising six containers 3, a circumferential adjustment path 5 and two circulating drive elements 41, 42. The circumferential, substantially rectangular adjustment path 5 each linearly connects the first and second adjustment positions 511, 512, the second and third adjustment positions 512, 513, the third and fourth adjustment positions 513, 514 as well as the fourth and first adjustment positions 514, 511. The two circulating and substantially rectangular drive elements 41, 42 are arranged with respect to each other in such a way that linear portions of both drive elements 41, 42 each are aligned parallel to each other. The first adjustment direction D1 here points from the first adjustment position 511 to the second adjustment position 512. The second adjustment direction D2 points from the second adjustment position 512 to the third adjustment position 513. The third adjustment direction D3 points from the third adjustment position 513 to the fourth adjustment position 514, and the fourth adjustment direction D4 points from the fourth adjustment position 514 to the first adjustment position 511. The first and the second adjustment direction D1, D2, the second and the third adjustment direction D2, D3, the third and the fourth adjustment direction D3, D4 as well as the fourth and the first adjustment direction D4, D1 each include a right angle.

Each of the circulating drive elements 41, 42 is arranged with respect to the respectively other drive element 41, 42 in such a way that at the four adjustment positions 511, 512, 513, 514 with four corresponding switching positions 521, 522, 523, 524 the positioning assembly is adapted to switch between the connection of the containers 3 to the first and second drive elements 41, 42. Thus, the positioning assembly is adapted to selectively transmit an adjusting force to at least one of the containers 3 via either the first drive element 41 or the second drive element 42.

In the second switching position 522, corresponding to the second adjustment position 512, the positioning assembly shown in FIG. 4A thus is adapted to switch between the connection of one of the containers 3 to the first circulating drive element 41 and the second circulating drive element 42. In the third switching position 523, corresponding to the third adjustment position 513, the positioning assembly furthermore is adapted to switch between the connection of the container 3 to the second circulating drive element 42 and the first circulating drive element 41. In the fourth switching position 524, corresponding to the fourth adjustment position 514, the positioning assembly furthermore is adapted to switch between the connection of the container 3 to the first circulating drive element 41 and the second circulating drive element 42. In the first switching position 521, corresponding to the first adjustment position 511, the positioning assembly furthermore is adapted to switch between the connection of the container 3 to the second circulating drive element 42 and the first circulating drive element 41.

The second, third and fourth adjustment positions 512, 513, 514 each are arranged within the stowage space 2. The first adjustment position 511 on the other hand is arranged in the removal area 1. In the arrangement of the containers 3 shown in FIG. 4A one of the six containers 3 is positioned on the first adjustment position 511 and hence in the removal area 1. A second and a third container 3 are arranged between the first and the second adjustment position 511, 512. A fourth container 3 is positioned in the third adjustment position 513. A fifth and a sixth container 3 are arranged between the third and fourth adjustment positions 513, 514.

All six of the illustrated containers 3 each include four connecting pins 61, two of which are each adapted to realize a plug connection 6 with one of the two drive elements 41, 42. For this purpose, the four connecting pins 61 are arranged parallel to each other in pairs on each of the containers 3. Furthermore, two connecting pins 61 of all containers 3 each are aligned parallel to two portions respectively of the rectangular adjustment path 5. Thus, the two pairs of connecting pins 61 of each container 3 include a right angle.

In the design variant shown in FIG. 4A, the two circulating drive elements 41, 42 are arranged with respect to each other in such a way that the third adjustment direction D3 is aligned antiparallel to the first adjustment direction D1, and the fourth adjustment direction D4 is aligned antiparallel to the first adjustment direction D1.

Thus, a container 3 can be adjusted by means of the positioning assembly via a sequential adjustment along the first adjustment direction D1, the second adjustment direction D2, the third adjustment direction D3 and the fourth adjustment direction D4 on a closed circulating movement.

The four containers 3 with two connecting pins 61 each are connected to the first drive element 41 between the first and second adjustment positions 511, 512 and between the third and fourth adjustment positions 513, 514. On the other hand, in the first and third adjustment positions 511, 513 the containers 3 are connected to the first drive element 41 by means of two of the connecting pins 61 and to the second drive element 42 by means of two of the connecting pins 61.

Thus, the first adjusting force can be transmitted to all of the six containers 3 by means of the first drive element 41. The containers 3 herewith can be adjusted along the first adjustment direction D1 between the first and second adjustment positions 511, 512 and at the first adjustment position 511. The containers 3 likewise can be adjusted along the third adjustment direction D3 between the third and fourth adjustment positions 513, 514 and at the third adjustment position 513.

Analogously, the second adjusting force can be transmitted to the containers 3 positioned at the first and third adjustment positions 511, 513 by means of the second drive element 42. The container 3 positioned at the first adjustment position 511 can be adjusted in a direction opposite to the second adjustment direction D2. The container 3 positioned at the third adjustment position 513 likewise can be adjusted in a direction opposite to the fourth adjustment direction D4.

Corresponding to the first and second adjusting forces to be designed independently of each other e.g., two different adjusting forces can be transmitted. Thus, as compared to the containers 3 in the first and third adjustment positions 511, 513, the containers 3 can be adjusted between the first and second adjustment positions 511, 512 and between the third and and fourth adjustment positions 513, 514 with adjustment speeds of different magnitude.

FIG. 4B shows another schematic representation of the storage device shown in FIG. 4A with containers adjusted with respect to FIG. 4A. As compared to the arrangement in FIG. 4A, the containers 3 are adjusted along the first adjustment direction D1 between the first and second adjustment positions 511, 512 and at the first adjustment position 511. The containers 3 likewise are adjusted along the third adjustment direction D3 between the third and the fourth adjustment position 513, 514 and at the third adjustment position 513.

Thus, the six containers 3 each are connected to the first drive element 41 by means of two connecting pins 61. Consequently, the first adjusting force can be transmitted to all of the six containers 3 by means of the first drive element 41. The containers 3 herewith can be adjusted along the first adjustment direction D1 between the first and second adjustment positions 511. The containers 3 likewise can be adjusted along the third adjustment direction D3 between the third and fourth adjustment positions 513, 514.

FIG. 4C shows yet another schematic representation of the storage device shown in FIG. 4A with containers 3 adjusted with respect to FIG. 4B. As compared to the arrangement shown in FIG. 4B the containers 3, which in FIG. 4B are arranged between the first and second adjustment positions 511, 512, are adjusted along the first adjustment direction D1. The container 3, which in FIG. 4B is arranged in the adjustment position nearest to the second adjustment position 512, furthermore is adjusted along the second adjustment direction D2. As compared to the arrangement shown in FIG. 4B the containers 3, which in FIG. 4B are arranged between the second and third adjustment positions 511, 512, likewise are adjusted along the third adjustment direction D3. The container 3, which in FIG. 4B is arranged in the adjustment position nearest to the fourth adjustment position 514, furthermore is adjusted along the fourth adjustment direction D4.

In an alternative embodiment, the containers can include connecting pins 61 that are adapted to create or release a plug connection 6 to one of the drive elements 41, 42, 43 in response to an electronic control signal.

In an alternative configuration, the containers 3 and drive elements 41, 42, 43 can be adapted to be connectable to each other via a magnetic connection in order to realize the releasable connection of the containers 3 to the drive elements 41, 42, 43. In one design variant, both the containers 3 and the drive elements 41, 42, 43 therefor can include permanent-magnetic connecting elements. In an alternative design variant, the containers 3 or the drive elements 41, 42, 43 can include electromagnetic connecting elements.

In another alternative configuration of an embodiment with a rectangular circumferential adjustment path 5, the positioning assembly can include four independent drive elements 41, 42, 43.

Alternatively, the two or more drive elements 41, 42, 43 also can be arranged relative to each other in such a way that the positioning assembly includes an adjustment path 5 that corresponds to the contour of a parallelogram. The four corners of the parallelogram here can correspond to four adjustment positions 511, 512, 513, 514. Thus, two of the adjustment positions 511, 512, 513, 514 each include an acute angle and two include an obtuse angle. To reduce the minimum spacing of the containers 3 to each other, the two of the adjustment positions 511, 512, 513, 514 with the acute angle can be configured as two switching positions 521, 522. In an exemplary embodiment, the positioning assembly in the first and the second switching position 521, 522 can be adapted to switch between the connection of one of the containers 3 to the first circulating drive element 41 and the second circulating drive element 42.

Furthermore, in each of the aforementioned embodiments the positioning assembly can define at least one guideway for guiding the containers 3 during the adjustment within the stowage space 2. Such a guideway can be adapted to support the weight force of each individual container 3 and of the objects possibly stored in the container 3. Thus, the guideway can relieve the at least two drive elements 41, 42, 43. In addition, the guideway, for example, can be adapted to support the containers 3 in the switching positions 521, 522, 523, 524 in such a way that the drive elements 41, 42, 43 adjacent in the switching positions 521, 522, 523, 524 are unloaded as regards the weight force of the containers 3 in the switching positions 521, 522, 523, 524.

In an alternative configuration, the at least one guideway can be a slotted link guide. For this purpose, the containers 3 can each sectionally engage in the slotted link guide. To realize the possibility of removal of the containers 3 from the storage device in the removal area 1, the storage device can be shaped such that only containers 3 positioned in the stowage space 2 engage in the slotted link guide.

In another configuration of the storage device the containers 3 have a rotatable engagement portion to realize a rotatable support in the guideway, via which engagement portion the containers 3 are guided along the at least one guideway.

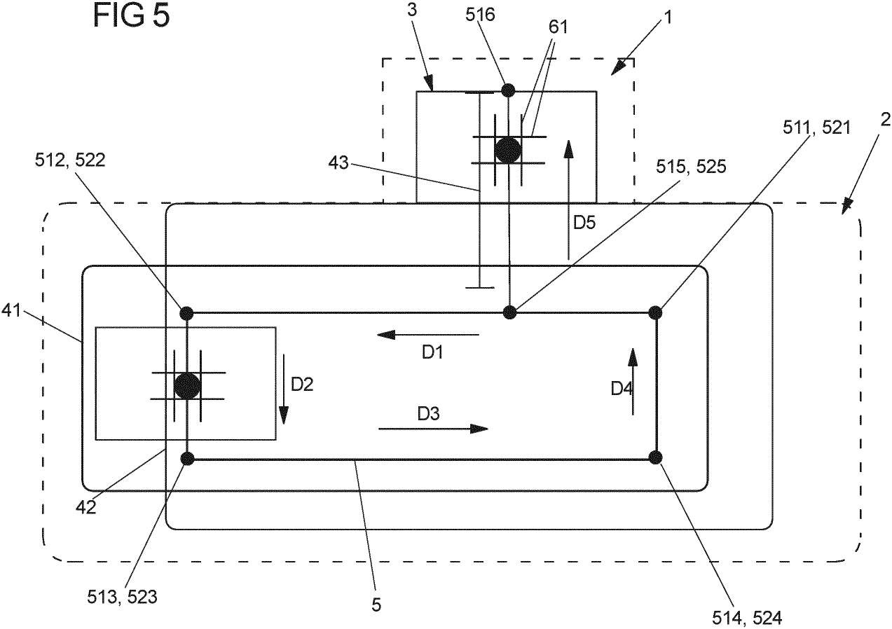

FIG. 5 shows a schematic representation of a fifth embodiment of the storage device with a circumferential portion of the adjustment path 5. The substantially rectangular circumferential portion of the adjustment path 5 each linearly connects the first and second adjustment positions 511, 512, the second and third adjustment positions 512, 513, the third and fourth adjustment positions 513, 514 as well as the fourth and first adjustment positions 514, 511. The two circulating and substantially rectangular drive elements 41, 42 are arranged with respect to each other in such a way that linear portions of both drive elements 41, 42 each are aligned parallel to each other. The first adjustment direction D1 here points from the first adjustment position 511 to the second adjustment position 512. The second adjustment direction D2 points from the second adjustment position 512 to the third adjustment position 513. The third adjustment direction D3 points from the third adjustment position 513 to the fourth adjustment position 514, and the fourth adjustment direction D4 points from the fourth adjustment position 514 to the first adjustment position 511. The first and the second adjustment direction D1, D2, the second and the third adjustment direction D2, D3, the third and the fourth adjustment direction D3, D4 as well as the fourth and the first adjustment direction D4, D1 each include a right angle.

Each of the circulating drive elements 41, 42 here is arranged with respect to the respectively other drive element 41, 42 in such a way that at the four adjustment positions 511, 512, 513, 514 the positioning assembly via four switching positions 521, 522, 523, 524 is adapted to switch between the connection of the containers 3 to the first and second drive elements 41, 42. Thus, the positioning assembly is adapted to selectively transmit an adjusting force to at least one of the containers 3 via either the first drive element 41 or the second drive element 42.

Furthermore, the adjustment path 5 includes a linear portion 53 which extends from a fifth adjustment position 515 arranged between the first and the second adjustment position 511, 512 to a sixth adjustment position 516. A third drive element 43 is arranged parallel to the linear portion 53 between the fifth and sixth adjustment positions 515, 516 in such a way that the third drive element 43 is aligned parallel to the second and fourth adjustment directions D2, D4. The fifth adjustment position 515 here corresponds to a fifth switching position 525 of the positioning assembly.

In the second switching position 522, corresponding to the second adjustment position 512, the positioning assembly shown in FIG. 5 thus is adapted to switch between the connection of one of the containers 3 to the first circulating drive element 41 and the second circulating drive element 42. In the third switching position 523, corresponding to the third adjustment position 513, the positioning assembly furthermore is adapted to switch between the connection of the container 3 to the second circulating drive element 42 and the first circulating drive element 41. In the fourth switching position 524, corresponding to the fourth adjustment position 514, the positioning assembly furthermore is adapted to switch between the connection of the container 3 to the first circulating drive element 41 and the second circulating drive element 42. In the first switching position 521, corresponding to the first adjustment position 511, the positioning assembly furthermore is adapted to switch between the connection of the container 3 to the second circulating drive element 42 and the first circulating drive element 41. In addition, in the fifth switching position 525, corresponding to the fifth adjustment position 515, the positioning assembly is adapted to switch between the connection of the container 3 to the first circulating drive element 41 and the third drive element 43.

The first, second, third, fourth and fifth adjustment positions 511, 512, 512, 513, 514, 515 each are arranged within the stowage space 2. The sixth adjustment position 516 on the other hand is arranged in the removal area 1. In the arrangement of the containers 3 shown in FIG. 5, one of the two illustrated containers 3 is positioned in the removal area 1. A second container 3 is arranged between the second and the third adjustment position 512, 513.

Both containers 3 each include four connecting pins 61, two of which are adapted to realize a plug connection with the first drive element 41, while the other two are adapted to realize a plug connection with the second or third drive element 42, 43. For this purpose, the four connecting pins 61 are arranged in pairs parallel to each other on each of the containers 3. Furthermore, the parallel two connecting pins 61 of all containers 3 likewise are aligned parallel to two portions each of the rectangular adjustment path 5. Thus, the two pairs of connecting pins 61 of each container 3 include a right angle.

In the design variant shown in FIG. 5, the two circulating drive elements 41, 42 are arranged with respect to each other in such a way that the third adjustment direction D3 is aligned antiparallel to the first adjustment direction D1, and the fourth adjustment direction D4 is aligned antiparallel to the first adjustment direction D1. A fifth adjustment direction D5 pointing from the fifth adjustment position 515 to the sixth adjustment position 516 is aligned parallel to the fourth adjustment direction D4.

Thus, the containers 3 can be adjusted within the stowage space 2 by means of the positioning assembly via a sequential adjustment along the first adjustment direction D1, the second adjustment direction D2, the third adjustment direction D3 and the fourth adjustment direction D4 on a closed circulating movement. In addition, the containers 3 can be adjusted from the fifth adjustment position 515 into the removal area 1 or from the removal area 1 into the fifth adjustment position 515.

In each of the design variants, the storage device can include a drive for the power-operated sequential displacement of the containers 3 between the adjustment positions 511, 512, 513, 514. The drive can be adapted to selectively drive the at least two drive elements 41, 42, 43 individually or jointly.

In an alternative configuration of the design variant, the drive can be electronically controllable. As an example, the positioning assembly can include an electronic control system connected to the electronically controllable drive. Such an electronic control system can be adapted to adjust a selected container 3 from the stowage space 2 into the removal area 1. For selection of a container 3 by a user, the positioning assembly therefor can include an input module.

In an exemplary configuration, the drive elements 41, 42, 43 can be chains, V-belts or threaded rods in all design variants of the storage device.

In another exemplary embodiment, the stowage space 2 of the storage device can include a cooling device in order to at least sectionally cool the stowage space 2. Thus, objects stored in at least one of the containers 3 can be cooled by being positioned in the cooled section of the stowage space 2. For the targeted adjustment of at least one container 3 into the cooled section of the stowage space 2, the electronic control system can be adapted to adjust a selected container 3 into the cooled section of the stowage space 2.

Alternatively or additionally, in another embodiment of the storage device the stowage space 2 can include a heating device in order to at least sectionally warm up the stowage space 2. Thus, objects stored in at least one of the containers 3 can be warmed up by being positioned in the warmed-up section of the stowage space 2. For the targeted adjustment of at least one container 3 in the warmed-up section of the stowage space 2, the electronic control system can be adapted to adjust a selected container 3 into the warmed-up section of the stowage space 2.

Via the cooling and/or heating device, objects stored in the containers 3 thus can specifically be tempered to a preferred temperature. An embodiment that includes both the cooling and the heating device thus can be adapted to temper objects to the preferred temperature independently of an ambient temperature. For isolating a cooled section from an uncooled section or a warmed-up section from a not warmed-up section or a cooled section from a warmed-up section, the positioning assembly here can include at least one linear portion 53 and a circulating portion of the adjustment path 5. The linear portion 53 can be arranged on the circumferential portion in such a way that at least one container 3 can be adjusted along the linear portion 53 from the warmed-up or cooled area into the uncooled or not warmed-up circumferential portion.

In one or more embodiments, the storage device also can include a plurality of removal areas 1. By means of the plurality of removal areas 1, the storage device can be adapted to provide for access to at least one of the containers 3 for one or more users at different positions. In an embodiment of the storage device comprising a plurality of removal areas 1, the positioning assembly can be adapted to adjust the plurality of containers 3 along an adjustment path 5 with a circumferential portion and a plurality of linear portions 53. The plurality of linear portions 53 can be arranged on the circumferential portion in such a way that the containers 3 can each be adjusted between the stowage space 2 and one of the removal areas 1 via one of the linear portions 53, respectively. Furthermore, in a plurality of switching positions 521, 522, 523, 524, 525 the positioning assembly can be adapted to switch between a connection of the containers 3 to the circumferential portion and one of the linear portions 53, respectively.

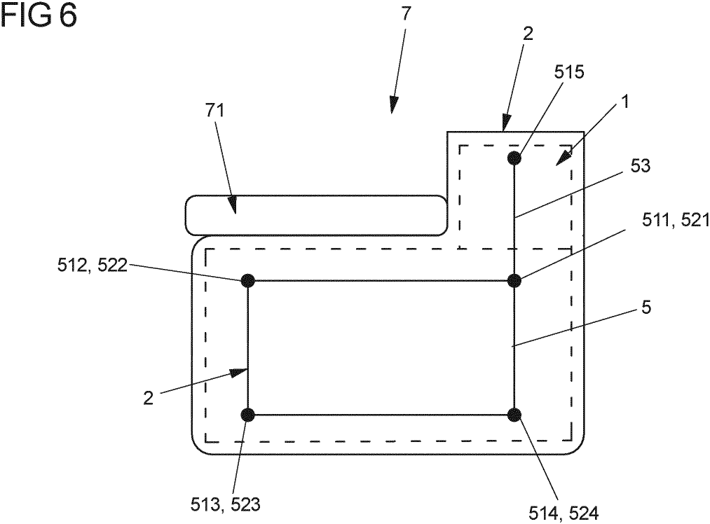

FIG. 6 shows a schematic representation of a center console 7 comprising a storage device. The representation of the storage device is limited to the removal area 1 and the stowage space 2 of the storage device as well as to the adjustment path 5, the adjustment positions 511, 512, 513, 514, 515 and the switching positions 521, 522, 523, 524 of the positioning assembly.

The center console 7 shown in FIG. 6 has an armrest surface 71. Furthermore, the center console 7 has an access portion 72 that allows a user to have access to the containers 3 positioned in the removal area 1 of the storage device.

For this purpose, the adjustment path 5 of the storage device comprises a linear portion 53 and a circumferential portion. The linear portion 53 here is arranged on the circumferential portion in such a way that the positioning assembly, in a switching position 521 corresponding to the first adjustment position 511, is adapted to switch between the connection of the containers 3 to the circumferential portion and the linear portion 53. Thus, the linear portion 53 connects the circumferential portion of the adjustment path 5 to the removal area 1.

In another embodiment of the center console 7 the storage device also can include a plurality of removal areas 1. Each of the plurality of removal areas 1 by way of example can be arranged at various positions of the vehicle. Accordingly, in one variant a first removal area 1 can be arranged in the region of a dashboard in such a way that via the first removal area 1 it is possible for a user sitting on a front seat to have access to containers 3. In an alternative or additional variant, a second removal area 1 can be arranged in a rear area with respect to the vehicle in such a way that via the second removal area 1 it is possible for a user sitting in the back of the vehicle to have access to containers 3.

In addition, embodiments of the center console 7 can include an electronic control system for electronically controlling the drive elements 41, 42, 43. The electronic control system can be connected to an on-board computer of a vehicle. Thus, a container 3 can be selected via the on-board computer so as to be adjusted into the removal area 1.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

List of reference numerals

| | |
|---|---|
| 1 | removal area |
| 2 | stowage space |
| 3 | container |
| 41 | first drive element |
| 42 | second drive element |
| 43 | third drive element |
| 5 | adjustment path |
| 511 | first adjustment position |
| 512 | second adjustment position |
| 513 | third adjustment position |
| 514 | fourth adjustment position |
| 515 | fifth adjustment position |
| 516 | sixth adjustment position |
| 521 | first switching position |
| 522 | second switching position |
| 523 | third switching position |
| 524 | fourth switching position |
| 525 | fifth switching position |
| 53 | linear portion |
| 6 | plug connection |
| 61 | connecting pin |
| 62 | pin receptacle |
| 7 | center console |
| 71 | armrest surface |
| 72 | access portion |
| D1 | first adjustment direction |
| D2 | second adjustment direction |
| D3 | third adjustment direction |
| D4 | fourth adjustment direction |
| D5 | fifth adjustment direction |

1. A storage device for use in a vehicle, the storage device comprising:
a plurality of containers configured to receive objects to be stored;
at least one removal area, configured to receive at least one container of the plurality of containers in such a way that the at least one of the at least one container of the and objects from the at least one container are removable by a user;
a stowage space configured to receive other containers of the plurality of containers, the other containers not positioned in the at least one removal area; and
a positioning assembly configured to adjust the plurality of containers along an adjustment path between the stowage space and the at least one removal areas,
the positioning assembly including,
at least two drive elements including a first drive element and a second drive element, wherein based on whether the at least one container is to be adjusted along the adjustment path between a first adjustment position and a second adjustment position or between the second adjustment position and a third adjustment position, either the first drive element or the second drive element is configured to selectively transmit an adjusting force to at least one of the containers.

2. The storage device of claim 1, wherein the at least two drive elements are arranged with respect to each other such that a first adjustment direction extending along the adjustment path from the first adjustment position to the second adjustment position, and a second adjustment direction extending along the adjustment path from the second adjustment position to the third adjustment position, form an angle with respect to each other.

3. The storage device of claim 1, wherein the positioning assembly disposed in at least one of the adjustment positions is configured to provide a closed circulating movement of the plurality of containers in the storage device,
such that a first container, connected to one of the first and second drive elements, is released from one of the first and second drive elements and
connected to the other one of the first and second drive elements.

4. The storage device of claim 1, wherein the positioning assembly includes a third drive element configured to selectively transmit the adjusting force to at least one of the containers, depending on whether the container is to be adjusted between the third adjustment position and a fourth adjustment position along the adjustment path or between a pairing of the adjustment positions deviating from the third and fourth adjustment positions.

5. The storage device of claim 1, wherein the at least two drive elements only include the first and second drive elements.

6. The storage device of claim 5, wherein the first drive element is configured to circulate to adjust the containers along the adjustment path between the first and second adjustment positions and between the third adjustment position and a fourth adjustment position along the adjustment path.

7. The storage device of claim 6, wherein the second drive element is configured to circulate to adjust the plurality of containers along the adjustment path between the second, third, fourth and first adjustment positions.

8. The storage device of claim 7, wherein first and second drive elements are arranged with respect to each other such that a third adjustment direction extending along the adjustment path from the third adjustment position to the fourth adjustment position is arranged antiparallel to the first adjustment direction, and a fourth adjustment direction extending along the adjustment path from the fourth adjustment position to the first adjustment position is arranged antiparallel to the second adjustment direction.

9. The storage device of claim 1, wherein the at least two drive elements are arranged two adjust the plurality of containers in two adjustment directions, the two adjustment directions intersecting at an adjustment position and form a right angle.

10. The storage device of claim 1, wherein the positioning assembly defines at least one guideway configured to guide the plurality of containers during the-adjustment within the stowage space.

11. The storage device of claim 10, wherein the at least one guideway is a slotted link guide configured to engage the plurality of containers stored in the stowage space.

12. The storage device of claim 10, wherein each of the containers of the plurality of containers includes at least one rotatable bearing, the at least one rotatable bearing configured to guide the plurality of containers in the at least one guideway.

13. The storage device of claim 1, wherein the positioning assembly includes a drive configured to selectively drive the at least two drive elements individually or jointly to provide sequential displacement of the containers between the adjustment positions.

14. The storage device of claim 13, wherein the drive is electronically controllable.

15. The storage device of claim 14, wherein the positioning assembly includes an electronic control system connected to the drive, the electronic control system configured to adjust a selected container from the stowage space to the at least one removal area.

16. The storage device of claim 1, wherein the at least two drive elements are formed of at least one of chains, V-belts, or threaded rods.

17. The storage device of claim 1, wherein the at least two drive elements are configured to be connected to the plurality of containers by a number of plug connections.

18. A center console of a vehicle, including the storage device claim 1.

19. A storage device for use in a vehicle, the storage device comprising:
a plurality of containers configured to receive objects to be stored;
at least one removal area, configured to receive a selected container of the plurality of containers such that at least one of the selected container of the plurality of containers and objects disposed in the selected container is removable;
a stowage space configured to receive other containers of the plurality of containers, the other containers not positioned in the at least one removal area; and
a positioning assembly configured to adjust the plurality of containers along an adjustment path between the stowage space and the at least one removal area, the positioning assembly including,
a first drive element and a second drive element, the first drive element configured to selectively transmit an adjusting force to the selected container to move the selected container along an adjustment path from a first adjustment position to a second adjustment position.

20. The storage device of claim 19, wherein the positioning assembly defines at least one guideway configured to guide the plurality of containers during adjustment within the stowage space.
